(19) United States
(12) Patent Application Publication
(10) Pub. No.: US 2026/0153785 A1
(43) Pub. Date: Jun. 4, 2026

(54) OPTICAL CONDUCTION ELEMENT, IMAGE CAPTURING MODULE, AND ELECTRONIC DEVICE

(71) Applicant: GUANGDONG OPPO MOBILE TELECOMMUNICATIONS CORP., LTD., Dongguan (CN)

(72) Inventors: Yi WEI, Dongguan (CN); Haiyu ZHANG, Dongguan (CN); Yaocheng TAN, Dongguan (CN); Xiangxi WU, Dongguan (CN); Yuchan GAO, Dongguan (CN); Jiawei CHEN, Dongguan (CN)

(73) Assignee: GUANGDONG OPPO MOBILE TELECOMMUNICATIONS CORP., LTD., Dongguan (CN)

(21) Appl. No.: 18/968,940

(22) Filed: Dec. 4, 2024

(51) Int. Cl. G03B 11/00; G03B 17/17; G03B 30/00; H04N 23/55; H04N 23/57

(52) U.S. Cl. CPC G03B 11/00; G03B 17/17; G03B 30/00; H04N 23/55; H04N 23/57

(57) ABSTRACT

An optical conduction element includes a body portion, having a light transmitting surface, a first reflective surface and a second reflective surface. The light transmitting surface has a light inlet region and a light outlet region. The body portion further has a bottom surface, which is connected to the first reflective surface and the second reflective surface and is disposed opposite to the light transmitting surface. The first reflective surface reflects at least a portion of light, which is emitted from the light inlet region to reach the first reflective surface, to propagate to reach the light transmitting surface; the light transmitting surface allows the light to pass through to propagate to reach the second reflective surface; and the second reflective surface reflects the light to propagate out of the light outlet region.

### TECHNICAL FIELD

Embodiments of the present disclosure relate to the technical field of image capturing devices, and more specifically, to an optical conduction element, an image capturing module, and an electronic device.

### BACKGROUND

An increasing number of electronic devices, such as smart phones, tablet computers, and e-readers, are arranged image capturing modules to capture images. In order to enable a configuration of a telephoto lens of the image capturing module to be adapted to a structural arrangement of the electronic device and to reduce a thickness of the electronic device, an image capturing module configured with a periscope is provided. The image capturing module configured with the periscope is arranged with an optical conduction element such as a prism to deflect a light propagating path, such that a size of the image capturing module in a thickness direction of the electronic device is reduced. However, in the image capturing module configured with the periscope, since the optical conduction element is arranged, the size of the image capturing module may be increased.

### SUMMARY

The present disclosure provides an optical conduction element, an image capturing module, and an electronic device, so as to solve the technical problem that the size of the image capturing module is increased due to arrangement of the optical conduction element.

In an aspect, the present disclosure provides an optical conduction element including a body portion, having a light transmitting surface, a first reflective surface and a second reflective surface. The light transmitting surface has a light inlet region and a light outlet region; the first reflective surface is inclined with respect to the light transmitting surface and is disposed in correspondence with the light inlet region; the second reflective surface is inclined with respect to the light transmitting surface and is disposed in correspondence with the light outlet region. The body portion further has a bottom surface; the bottom surface is connected to the first reflective surface and the second reflective surface and is disposed opposite to the light transmitting surface. The optical conduction element is configured to take the first reflective surface to reflect at least a portion of light, which is emitted from the light inlet region to reach the first reflective surface, to propagate to reach the light transmitting surface; the light transmitting surface is configured to allow the at least the portion of light to pass through to propagate to reach the second reflective surface; and the second reflective surface is configured to reflect the at least the portion of light to propagate out of the light outlet region.

According to the optical conduction element of the present disclosure, at least a portion of the light that enters the body portion from the light inlet region is reflected by the first reflective surface to propagate to reach the light transmitting surface, and is further reflected by the light transmitting surface to propagate to the second reflective surface, and is further reflected by the second reflective surface to propagate to the light outlet region. Furthermore, the at least the portion of the light is emitted out of the optical conduction element from the light outlet region. The bottom surface is connected to the first reflective surface and the second reflective surface, and therefore, a cross section of the body portion of the optical conduction element is substantially trapezoidal.

In another aspect, the present disclosure provides an image capturing module, including a lens, an image sensor, and the optical conduction element as described in the above. The light inlet region is located corresponding to a light outlet side of the lens; the light outlet region is located corresponding to a light sensing surface of the image sensor.

In still another aspect, the present disclosure provides an electronic device, including a housing and the image capturing module as described in the above. The housing defines a light inlet hole, the light inlet side of the lens is disposed corresponding to the light inlet hole.

### BRIEF DESCRIPTION OF THE DRAWINGS

In order to more clearly illustrate technical solutions in embodiments of the present disclosure or in the related art, the accompanying drawings for describing the embodiments or the related art will be briefly introduced below. Obviously, the accompanying drawings shows only some of the embodiments of the present disclosure. Any ordinary skilled person in the art may obtain other accompanying drawings according to the drawings without making any creative work.

FIG. 1 is a structural schematic view of an electronic device according to an embodiment of the present disclosure.

FIG. 2 is a structural schematic view of an image capturing module according to an embodiment of the present disclosure.

FIG. 3 is a structural schematic view of a second light absorbing film arranged on a first sub-prism according to an embodiment of the present disclosure.

FIG. 4 is a structural schematic view of a third light absorbing film arranged on a first reflective surface according to an embodiment of the present disclosure.

FIG. 5 is a structural schematic view of a fifth light absorbing film arranged on a light transmitting surface according to an embodiment of the present disclosure.

FIG. 6 is a structural schematic view of a light absorbing region of the light transmitting surface configured with a diffuse reflective surface according to an embodiment of the present disclosure.

FIG. 7 is a cross-sectional view of a reflective film according to some embodiments of the present disclosure.

FIG. 8 is a reflectivity curve of the reflective film shown in FIG. 7.

FIG. 9 is a cross-sectional view of the reflective film according to another embodiment of the present disclosure.

FIG. 10 is a reflectivity curve of the reflective film shown in FIG. 9.

FIG. 11 is a cross-sectional view of the reflective film according to still another embodiment of the present disclosure.

FIG. 12 is a cross-sectional view of the reflective film according to still another embodiment of the present disclosure.

FIG. 13 is a reflectivity curve of the reflective film shown in FIG. 12.

FIG. 14 is a cross-sectional view of the reflective film having a first protective film omitted according to an embodiment of the present disclosure.

FIG. 15 is a reflectivity curve of the reflective film shown in FIG. 14.

FIG. 16 is a cross-sectional view of layered structures of the second light absorbing film according to an embodiment of the present disclosure.

FIG. 17 is a reflectivity curve of the second light absorbing film according to an embodiment of the present disclosure.

FIG. 18 is an OD value curve of the second light absorbing film according to an embodiment of the present disclosure.

FIG. 19 is a structural schematic view of other components in an electronic device according to an embodiment of the present disclosure.

### REFERENCE NUMERALS

10, electronic device; 11, housing; 111, light inlet hole; 12, image capturing module; 121, lens; 1211, optical lens; 122, image sensor; 123, optical conduction element; 1231, body portion; 1232, first reflective surface; 1233, second reflective surface; 1234, light transmitting surface; 1235, light inlet region; 1236, light outlet region; 1237, light absorbing region; 1238, assembling position; 1239, bottom surface; 1241, first sub-prism; 1242, second sub-prism; 1243, chamfer; 1244, first light absorbing film; 1245, second light absorbing film; 1246, opening; 1247, light absorbing member; 1248, third light absorbing film; 1249, fourth light absorbing film; 125, infrared filter; 126, first reflective region; 127, a second reflective region; 128, a reflective film; 129, a fifth light absorbing film.

### DETAILED DESCRIPTIONS

In order to facilitate understanding of the present disclosure, the present disclosure will be described in more detail below by referring to the accompanying drawings. Preferred embodiments of the present disclosure are provided with the accompanying drawings. However, the present disclosure can be achieved in various forms and is not limited to the embodiments described herein. Rather, these embodiments are provided for the purpose of providing a more thorough and comprehensive understanding of the present disclosure.

The “electronic device” in the present disclosure means a device that is capable of receiving and/or transmitting communication signals and is connected by any one or more of the following connection manners:
(1) By means of wired connection, such as by a public switched telephone network (PSTN), a digital subscriber line (DSL), a digital cable, or a direct cable connection;
(2) By wireless interfaces such as a cellular network, a wireless local area network (WLAN), a digital television network such as a DVB-H network, a satellite network, an AM-FM radio transmitter.

An electronic device that is configured to communicate via a wireless interface may be referred to as a “mobile terminal”. Examples of the mobile terminal include, but are not limited to, the following:
(1) a satellite or cellular telephones;
(2) a personal communications system (PCS) terminal that combines a cellular radiotelephone with data processing, facsimile, and data communication capabilities;
(3) a radiotelephones, a pager, an internet/intranet access, a web browser, an organizer, a calendars, a personal digital assistant (PDA) configured with a global positioning system (GPS) receiver;
(4) a conventional laptop and/or palmtop receiver; and
(5) a conventional laptop and/or palmtop radiotelephone transceiver.

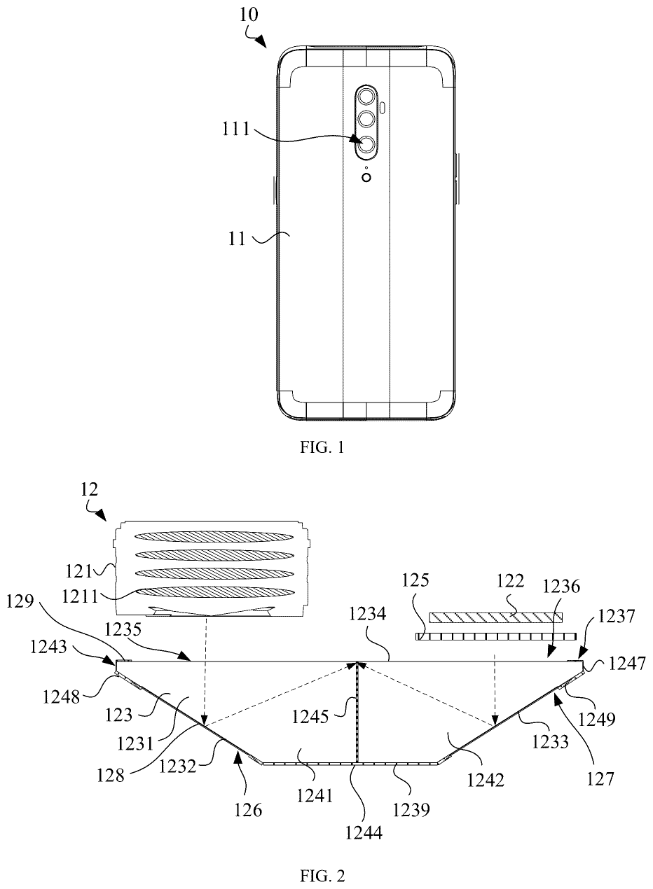

As shown in FIGS. 1 and 2, FIG. 1 is a structural schematic view of an electronic device 10 according to an embodiment of the present disclosure; and FIG. 2 is a structural schematic view of an image capturing module 12 according to an embodiment of the present disclosure. The electronic device 10 includes, but is not limited to, a smart phone, a tablet computer, an e-reader, a wearable device, and any device having an image capturing function. In the present embodiment, the electronic device 10 is described as the smart phone as an example.

In some embodiments, the electronic device 10 includes a housing 11 and an image capturing module 12. The image capturing module 12 is arranged on the housing 11, the electronic device 10 is arranged with the image capturing module 12 to achieve an image capturing function. The image capturing module 12 may be configured to be periscopic to reduce a size of the image capturing module 11 in a thickness direction of the electronic device 10 to optimize a structural arrangement of the electronic device 10 and to reduce a thickness of the electronic device 10. An assembling relationship between the housing 11 and the image capturing module 12 is not limited herein and may be specifically designed according to the structural arrangement of the electronic device 10. For example, in some embodiments, the housing 11 includes a middle frame, a front cover plate, and a rear cover plate. The center frame may be substantially a rectangular frame, the front cover plate and the rear cover plate respectively cover two sides of the center frame, such that the center frame, the front cover plate and the rear cover plate cooperatively define a receiving space. The image capturing module 12 may be received in the receiving space of the housing 11. In the present disclosure, a direction from the front cover plate of the housing 12 towards the rear cover plate of the housing 11 may be regarded as the thickness direction of the electronic device 10.

In some embodiments, the image capturing module 12 includes a lens 121, an image sensor 122, and an optical conduction element 123. The lens 121 is configured to collect light, the lens 121 may include a plurality of optical lenses 1211, each of the plurality of optical lenses 1211 has an optical focal length. The plurality of optical lenses 1211 operate cooperatively to correct aberration while collecting the light, such that imaging quality of the image capturing module 12 is improved. The image sensor 122 includes, but is not limited to, a charge coupled device (CCD) or a complementary metal-oxide semiconductor (CMOS) sensor. The optical conduction element 123 is configured to conduct the light from the lens 121 to the image sensor 122 to form an image, such that the electronic device 10 achieves the image capturing function. In some embodiments, the housing 11 defines a light inlet hole 111 extending through the housing. When the image capturing module 12 is received in the housing 11, a light inlet side of the lens 121 corresponds to the light inlet hole 111 so as to collect the light entering from the light inlet hole 111. An optical axial direction of the lens 121 may be substantially parallel to the thickness direction of the electronic device 10. By arranging the optical conduction element 123 to deflect a light propagating path while conducting the light, a periscopic configuration is achieved, such that the size of the image capturing module 12 in the thickness direction of the electronic device 10 is reduced.

The lens 121 may include a plurality of optical lenses 1211, each of the plurality of optical lenses 1211 has the optical focus, and the number of the plurality of optical lenses 1211 and a type of each of the plurality of optical lenses 1211 are not limited herein. In some embodiments, the lens 121 sequentially includes, along an optical axis, four optical lenses 1211 that are spaced apart from each other. A first optical lens 1211 of the lens 121 is located nearest to the light inlet hole 111 and may be made of glass and processed and molded by grinding. The first optical lens 1111 is substantially configured to correct the aberration and to eliminate a temperature drift. The other three optical lenses 1211 of the lens 121 may be made of plastic and processed and molded by injection molding. The other three optical lenses 1211 are substantially configured to correct the aberration. It is understood that the present embodiment only lists materials and processing methods of the above optical lenses 1211, but does not limit the materials and the processing methods. The materials and the processing methods of the above optical lenses 1211 may be determined by any ordinary skilled person in the art according to the actual needs.

As shown in FIG. 2, in some embodiments, an optical axis of the lens 121 is sustainably parallel to an axis of the image sensor 122. The optical conduction element 123 is configured to be capable of deflecting the light propagating path by 180°. The optical conduction element 123 has a region configured to receive light emitted from the lens 121 and another region configured to output the light to the image sensor 122, and the region and the another region may be oriented to a same side. In some embodiments, the optical conduction element 123 has a light inlet region 1235 and a light outlet region 1236, the light inlet region 1235 is located in correspondence with a light outlet side of the lens 121 and is configured to receive light emitted from the lens 121. The light outlet region 1236 is disposed corresponding to a light sensing side of the image sensor 122 and is configured to output the light to the image sensor 122. In some embodiments, the light inlet region 1235 and the light outlet region 1236 are coplanar, and a plane in which the light inlet region 1235 and the light outlet region 1236 are located is substantially perpendicular to the optical axis of the lens 121 and the axis of the image sensor 122.

To be noted that the optical conduction element 123 can deflect the light propagating path by 180°, such that the lens 121 and the image sensor 122 can be disposed on a same side of the optical conduction element 123, and therefore, the lens 121 and the image sensor 122 are at least partially overlapped with each other in an optical axial direction of the lens 121. In this way, the size of the image capturing module 12 in the thickness direction of the electronic device 10 is reduced, a space occupied by the image capturing module 12 in the thickness direction of the electronic device 10 is reduced. In the present application, the axis of the image sensor 122 may be perpendicular to the light sensing surface of the image sensor 122.

In some embodiments, the optical conduction element 123 is configured to be able to reflect the light emitted from the lens 121 for at least three times to direct light to propagate to reach the image sensor 122. In this way, the light propagating path at a rear side of the lens 121 is extended, enabling the optical conduction element 123 to adapt to a telephoto configuration of the lens 121. In this way, a sufficient optical magnification is achieved, and the space occupied by the image capturing module 12 is reduced.

In some embodiments, the optical conduction element 123 has a first reflective surface 1232, a second reflective surface 1233, and a light transmitting surface 1234. The light inlet region 1235 and the light outlet region 1236 are both formed on the light transmitting surface 1234. In other words, different regions of the light transmitting surface 1234 respectively face the lens 121 and the image sensor 122. The first reflective surface 1232 is inclined with respect to the light transmitting surface 1234 and is disposed corresponding to the light inlet region 1235. The second reflective surface 1233 is inclined with respect to the light transmitting surface 1234 and is disposed corresponding to the light outlet region 1236. At least a portion of the light from the lens 121 enters the optical conduction element 123 from the light inlet region 1235 and is directed to the first reflective surface 1232. The first reflective surface 1232 reflects the at least the portion of the light reaching the first reflective surface 1232 to propagate to reach the light transmitting surface 1234. The light transmitting surface 1234 can reflect the at least the portion of the light, which is directed from the first reflective surface 1232 to reach the light transmitting surface 1234, to propagate to reach the second reflective surface 1233. The second reflective surface 1233 reflects the at least the portion of the light, which is reflected from the light transmitting surface 1234 to the second reflective surface 1233, to propagate to reach the light outlet region 1236. In this way, the at least the portion of the light is output from the light output region 1236 out of the optical conduction element 123 to reach the image sensor 122. According to the above description, the light transmitting surface 1234 may be substantially perpendicular to the axis of the lens 121 and the axis of the image sensor 122.

In some embodiments, each of an angle between the first reflective surface 1232 and the light-transmitting surface 1234 and an angle between the second reflective surface 1233 and the light-transmitting surface 1234 is greater than or equal to 25° and less than or equal to 35°, which may be 32.5°, for example. In this way, an efficiency and accuracy of the first reflective surface 1232, the second reflective surface 1233, and the light-transmitting surface 1234 in reflecting light may be improved, such that the optical conduction element 123 can successfully deflect the light propagating path by 180°.

The optical conduction element 123 in the present embodiment reflects the at least the portion of the light for three times to direct the light to reach the image sensor 122. In this way, the optical conduction element 123 is applicable to the telephoto configuration of the lens 121. Based on the periscopic configuration in combination with the telephoto configuration of the lens 121, the size of the image capturing module 12 in the thickness direction of the electronic device 10 is reduced. For example, the optical conduction element 123 is applicable to a lens 121 having a 2 times to 4 times (equivalent focal lengths of approximately 40 mm to 90 mm) magnification. When the lens 121 of the image capturing module 12 has a higher magnification, the optical conduction element 123 may deflect the light for a greater number of times to further increase the light propagating path in the optical conduction element 123, such that the telephoto configuration of the lens 121 is applicable.

It is noted that the first reflective surface 1232 and the second reflective surface 1233 may be connected to each other, i.e., the optical conduction element 123 may be substantially in a shape of a prism. As shown in FIG. 2, in some embodiments, the optical conduction element 123 may further have a bottom surface 1239 connected to the first reflective surface 1232 and the second reflective surface 1233. The bottom surface 1239 is opposite to the light transmitting surface 1234. For example, the bottom surface 1239 is substantially parallel to the light transmitting surface 1234, and in this case, a cross section of the optical conduction element 123 may be substantially isosceles trapezoidal. Of course, the bottom surface 1239 shall be disposed at a position avoiding an effective field of view range of the first reflective surface 1232 and the second reflective surface 1233, or a portion of the bottom surface 1239 is disposed corresponding to stray light at an edge of the effective field of view, such that normal imaging of the image capturing module 12 is not affected. The bottom surface 1239 of the optical conduction element 123 may be formed by performing a cutout on the prism or may be formed directly in a process of injection molding. As long as the image quality of the image capturing module 12 is not affected, compared to the prism, arranging the bottom surface 1239 can reduce the size of the optical conduction element 123 in the optical axial direction of the lens 121, such that the size of the image capturing module 12 in the thickness direction of the electronic device 10 is reduced.

In some embodiments, a body portion 1231 of the optical conduction element 123 may be the prism. The first reflective surface 1232, the second reflective surface 1233, the light transmitting surface 1234, and the bottom surface 1239 are all arranged on the body portion 1231. A material of the body portion 1231 includes, but is not limited to, glass or plastic. A refractive index of the body portion 1231 may be in a range of 1.5 to 1.9, such that the light propagating path can be effectively deflected, and the periscopic configuration of the image capturing module 12 is achieved. For example, a material of the body portion 1231 may be glass, and the refractive index of the body portion 1131 may be 1.61.

In some embodiments, the optical conduction element 123 further includes a first light absorbing film 1244. The first light absorbing film 1244 is disposed on the bottom surface 1239 of the body portion 1231. The first light absorbing film 1244 may cover the entire bottom surface 1239, and a material of the first light absorbing film 1244 may be any applicable material having proper light absorbing ability, such as ink. The first light absorbing film 1244 can effectively absorb light that reaches the bottom surface 1239, preventing the light from reflecting at the bottom surface 1239 to form the stray light, such that the imaging quality of the image capturing module 12 is improved. In some embodiments, the bottom surface 1239 is configured as the diffuse reflective surface, including but not limited to the matte surface or the frosted surface. In this way, the bottom surface 1239 can diffusively reflect the light reaching the bottom surface 1239, brightness of the light is reduced. Therefore, the light can be absorbed by the first light absorbing film 1244 more easily, and brightness of the light reflected by the bottom surface 1239 is reduced, and the brightness of the stray light in the optical conductive element 123 is reduced, preventing the stray light from affecting the imaging quality of the image capturing module 12.

The body portion 1231 may be a one-piece prism or may be formed by gluing a plurality of prisms to each other, as long as the light propagating path can be deflected. In some embodiments, the body portion 1231 includes a first sub-prism 1241 and a second sub-prism 1242, the first sub-prism 1241 and the second sub-prism 1242 are glued to each other by an optical glue to form the body portion 1231. A side of the first sub-prism 1241 away from the second sub-prism 1242 forms the first reflective surface 1232. A side of the second sub-prism 1242 the first sub-prism 1241 forms the second reflective surface 1233. A surface of the first sub-prism 1241 facing the lens 121 and a surface of the second sub-prism 1242 facing the image sensor 122 cooperatively form the light transmitting surface 1234. A surface of the first sub-prism 1241 away from the lens 121 and a surface of the second sub-prism 1242 away from the image sensor 122 cooperatively form the bottom surface 1239.

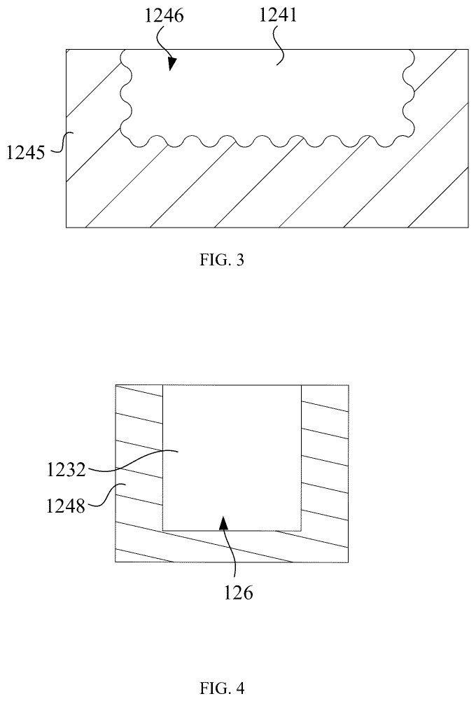

As shown in FIGS. 2 and 3, in some embodiments, the optical conduction element 123 further includes a second light absorbing film 1245, the second light absorbing film 1245 is disposed at an intersection between the first sub-prism 1241 and the second sub-prism 1242. For example, two opposite sides of the second light absorbing film 1245 are respectively attached to the surface of the first sub-prism 1241 facing the second sub-prism 1242 and the surface of the second sub-prism 1242 facing the first sub-prism 1241. Alternatively, only one surface of the second light absorbing film 1245 may be attached to the first sub-prism 1241 or the second sub-prism 1242; and the other surface of the second light absorbing film 1245 may be attached to the optical glue between the first sub-prism 1241 and the second sub-prism 1242. A material of the second light absorbing film 1245 includes, but is not limited to, ink or any applicable material having good light absorbing performance. The second light absorbing film 1245 defines a light through aperture between the first sub-prism 1241 and the second sub-prism 1242. It is understood that when light propagating in the optical conduction element 123 passes through the second light absorbing film 1245, only light corresponding to the light through aperture defined by the second light absorbing film 1245 can pass through the second light absorbing film 1245, and the rest of the light is absorbed by the second light absorbing film 1245. In this way, the stray light component in the image capturing module 12 is reduced, and the imaging quality of the shooting module 12 is improved.

In some embodiments, each of a projection of the second light absorbing film 1245 on the surface of the first sub-prism 1241 facing the second sub-prism 1242 and a projection of the second light absorbing film 1245 on the surface of the second sub-prism 1242 facing the first sub-prism 1241 has an opening 1246 facing towards the light transmitting surface 1234. The opening 1246 corresponds to the light through aperture. In this way, the second light absorbing film 1245 can absorb at least a portion of the stray light reflected from the first reflective surface 1232 onto the light transmitting surface 1234 and absorb at least a portion of the stray light reflected from the light transmitting surface 1234 onto the second reflective surface 1233. In this way, the stray light component of the image capturing module 12 can be reduced.

Further, as shown in FIG. 3, in some embodiments, the second light absorbing film 1245 has a curved edge corresponding to at least a portion of an edge of the opening 1246. Providing the curved edge facilitates reducing a diffraction effect of light at the edge of the second light absorbing film 1245, such that the stray light is prevented from being generated, and the imaging quality of the image capturing module 12 is improved. In some embodiments, the second light absorbing film 1245 has a plurality of curved edges that are periodically distributed and correspond to the edge of the opening 1246. A radius of each of the plurality of curved edges may be 0.1 mm-0.3 mm, such as 0.2 mm. In this way, the diffraction effect of the light at the edge of the second light absorbing film 1245 corresponding to the opening 1246 is reduced, and the stray light is prevented from being generated.

Two opposite edges of the light transmitting surface 1234 may be connected to the first reflective surface 1232 and the second reflective surface 1233, respectively. As shown in FIG. 2, in some embodiments, a chamfer 1243 is arranged for transition at each of a transition between the light transmitting surface 1234 and the first reflective surface 1232 and a transition between the light transmitting surface 1234 and the second reflective surface 1233. The chamfer 1243 may be inclined with respect to or perpendicular to the light transmitting surface 1234. Compared to the technical solution in which the first reflective surface 1232 and the second reflective surface 1233 are directly connected to the light transmitting surface 1234, the chamfer 1243 is arranged to prevent the two ends of the body portion 1231 from being excessively sharp, such that a risk of the optical conduction element 113 being chipped, during production or assembling, is reduced.

In some embodiments, the optical conduction element 123 further includes a light absorbing member 1247 disposed at the chamfer 1243 between the light transmitting surface 1234 and the first reflective surface 1232 and another light absorbing member 1247 disposed at the chamfer 1243 between the light transmitting surface 1234 and the second reflective surface 1233. A material of each light absorbing member 1247 includes, but is not limited to, a material such as an ink having proper light absorbing performance. By arranging the light absorbing member 1247 at the chamfer 1243, light reaching the chamfer 1243 can be absorbed, preventing the light from reflecting at the chamfer 1243 to form the stray light. The stray light components in the image capturing module 12 are reduced, and the imaging quality of the image capturing module 12 is improved.

In some embodiments, the optical conduction element 123 further includes a third light absorbing film 1248 and a fourth light absorbing film 1249. The third light absorbing film 1248 is disposed on the first reflective surface 1232, the third light absorbing film 1248 defines the diameter of the light through aperture of the first reflective surface 1232. The fourth light absorbing film 1249 is disposed on the second reflective surface 1233 and defines the diameter of the light through aperture of the second reflective surface 1233. A material of each of the third light absorbing film 1248 and the fourth light absorbing film 1249 includes, but are not limited to, a material having proper light absorbing performance, such as ink. The third light absorbing film 1248 and the fourth light absorbing film 1249 are arranged to absorb light that reaches the first reflective surface 1232 and the second reflective surface 1233 and is located outside of the light through aperture. In this way, the light is prevented from reflecting at the first reflective surface 1232 and the second reflective surface 1233 to form the stray light, the stray light component in the image capturing module 11 is reduced, and the imaging quality of the image capturing module 12 is improved.

It is understood that a region on the first reflective surface 1232 and the second reflective surface 1233 for reflecting the light to enable the light to achieve the imaging of the image capturing module 12 can be regarded as a region of the light through aperture of the first reflective surface 1232 and the second reflective surface 1233. Light directed to the region of the light through aperture of the first reflective surface 1232 and the second reflective surface 1233 can be reflected and ultimately directed to the image sensor 122 to achieve the imaging of the image capturing module 12. It can be understood that the third light absorbing film 1248 defines a first reflective region 126 on the first reflective surface 1232, and the fourth light absorbing film 1249 defines a second reflective region 127 on the second reflective surface 1233. The first reflective region 126 corresponds to the light through aperture of the first reflective surface 1232, and the second reflective region 127 corresponds to the light through aperture of the second reflective surface 1233. Both the first reflective region 126 and the second reflective region 127 can reflect light.

It is to be noted that, by reasonably configuring angles and orientations of the first reflective surface 1232, the second reflective surface 1233 and the light transmitting surface 1234, as well as a refractive index of the body portion 1231, a light incidence angle on the light transmitting surface 1234 in which light is reflected by the first reflective surface 1232 to reach the light transmitting surface 1234 meets a demand for total reflection. In this way, light reflectivity of the light transmitting surface 1234 can be improved to enhance a light utilization efficiency and the imaging quality. However, a light incidence angle on the first reflective surface 1232 and a light incidence angle on the second reflective surface 1233 are small, and a critical angle of total reflection cannot be reached. Therefore, in order to improve the light reflectivity of the first reflective surface 1232 and the second reflective surface 1233 to improve utilization of the light and the imaging quality of the image capturing module 12, in some embodiments, a reflective film 128 may be arranged on each of the first reflective region 126 of the first reflective surface 1232 and the second reflective region 127 of the second reflective surface 1233. The reflective film 128 may improve the light reflectivity on the first reflective region 126 and on the second reflective region 127. The reflective film 128 includes, but is not limited to, a metallic film layer having proper light reflective performance, which may be a silver plating.

As shown in FIGS. 2 and 3, it is understood that each of the first reflective region 126 and the second reflective region 127 may be substantially square. When the chamfer 1243 is arranged at each of the transition between the light transmitting surface 1234 and the first reflective surface 1232 and the transition between the light transmitting surface 1234 and the second reflective surface 1233, the third light absorbing film 1248, the fourth light absorbing film 1249 and the light absorbing members 1247 arranged on the chamfers 1243 may cooperatively define a substantially annular region. When the body portion 1231 is not arranged with any chamfer 1243, the third light absorbing film 1248 and the fourth light absorbing film 1249 may be arranged to be substantially annular.

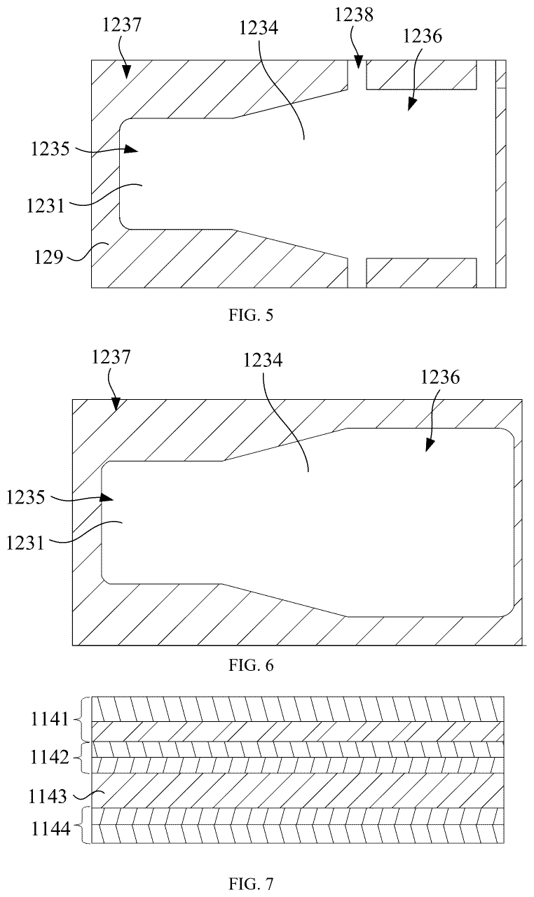

As shown in FIGS. 2, 5, and 6, in some embodiments, the light transmitting surface 1234 is arranged with a light absorbing region 1237, which is substantially annular. The light inlet region 1235 and the light outlet region 1236 are both located within the light absorbing region 1237. The light inlet region 1235 and the light outlet region 1236 may be two adjacent regions or two regions that are spaced apart from each other and are located within the light absorbing region 1237. In some embodiments, the optical conduction element 123 may further include a fifth light absorbing film 129 disposed in the light absorbing region 1237 covering at least a portion of the light absorbing region 1237. A material of the fifth light absorbing film 129 includes, but is not limited to, a material having proper light absorbing performance, such as ink. The fifth light absorbing film 129 can absorb light, which is emitted from outside of the body portion 1231 to reach the light absorbing region 1237. In this way, light is prevented from reflecting or propagating into the body portion 1231 to form the stray light. The fifth light absorbing film 129 can also absorb light, which is emitted from an inside of the body portion 1231 onto the light absorbing region 1237. In this way, the light is prevented from reflecting to form the stray light. Therefore, the stray light component in the image capturing module 12 is reduced, and the imaging quality of the image capturing module 12 is improved. In some embodiments, the light absorbing region 1237 may be provided with an assembling position 1238, and the fifth light absorbing film 129 is arranged by avoiding the assembling position 1238. Arranging the assembling position 1238 and the fifth light absorbing film 129, a color visual aberration is formed to enable the lens 121, the image sensor 122, or the optical conduction element 123 to be aligned. In this way, assembling precision of various components of the image capturing module 12 is improved, the imaging quality of the image capturing module 12 is improved.

Further, as shown in FIG. 6, in some embodiments, a portion of the light transmitting surface 1234 corresponding to the light absorbing region 1237 is configured as the diffuse reflective surface, such as the matte surface or the frosted surface. In this way, the light reaching the light absorbing region 1237 can be diffusively reflected to reduce brightness of the light, such that the light can be absorbed by the fifth light absorbing film 129 more easily, brightness of the light reflected in the light absorbing region 1237 is reduced, and an influence caused by the stray light on the imaging quality is reduced.

It is to be noted that, in order to facilitate distinguishing various elements, in the accompanying drawings of the present disclosure, elements having the light absorbing function are illustrated by a sectional line, such as shown in FIGS. 2-FIG. 5, each of the above-mentioned light absorbing films and light absorbing member 1247 are illustrated by the sectional line, and regions corresponding to the diffuse reflective surfaces are illustrated by the sectional line in FIG. 6. Each of the above-mentioned light absorbing films and the light absorbing member 1247 may be formed on the body portion 1231 by performing silk screen printing or spin painting or coating.

In some embodiments, the image capturing module 12 may further include an infrared filter 125, the infrared filter 125 may be disposed between the optical conduction element 123 and the image sensor 122. The infrared filter 125 may be configured to filter out the interfering light, preventing the interfering light from being directed to the image sensor 122 and affecting normal imaging of the image capturing module 12.

Further, as shown in FIGS. 2 and 7, in some embodiments, each of the reflective film 128 on the first reflective surface 1232 and the reflective film 128 on the second reflective surface 1233 includes a first reflective enhancement film 1141, a first protective film 1142, an aluminum (Al) film 1143, and a second protective film 1144, which are laminated sequentially.

The first reflective enhancement film 1141 includes a silicon dioxide (SiO₂) layer and a titanium dioxide (TiO₂) layer disposed on a surface of the SiO₂ layer facing the first protective film 1142. When the reflective film 128 is disposed on the first reflective surface 1232 or the second reflective surface 1233, the first reflective film 1141 is disposed facing towards the body portion 1231, and the SiO₂ layer on the first reflective enhancement film 1141 is located near the body portion 1231. Each of the first protective film 1142 and the second protective film 1144 an aluminum oxide (Al₂O₃) to the Al film 1144.

The above-described reflective film 128 is arranged with the Al film 1143 to reflect light. In this way, reflectivity of the light reflected by the first reflective surface 1232 and the second reflective surface 1233 is improved. At the same time, by arranging the first reflective film 1141 facing towards the body portion 1231 and arranging the titanium dioxide layer and the aluminum oxide layer in the first reflective enhancement film 1141, reflectivity of the light reflected by the reflective film 128 is improved. In combination with reflectivity of the aluminum film 1143, the reflective film 128 has a good reflective efficiency. When the reflective film 128 is arranged on the first reflective surface 1232 and the second reflective surface 1233, the first reflective surface 1232 and the second reflective surface 1233 reflect more light, a light utilization efficiency and an aperture of the image capturing module 12 are improved, and a loss of light on the reflective film 128 is reduced, such that the imaging quality is improved. In addition, the aluminum oxide in the first protective film 1142 and the second protective film 1144 can be tightly combined with the aluminum film 1143, preventing the aluminum film 1143 from being oxidized and affecting the reflection efficiency, such that performance stability of the reflection film 128 is improved. In the first reflective film 1141, the SiO₂ layer is arranged on the side of the titanium dioxide layer away from the first protective film 1142, and in this way, the reflectivity of the reflective film 128 is improved, the titanium dioxide layer is protected, and performance stability and structural strength of the reflective film 128 are improved.

A layered structure of the reflective film 128 in some embodiments and a thickness of each layer of the layered structure are given in Table 1 below. The reflective film 128 shown in Table 1 corresponds to the reflective film 128 in the embodiment shown in FIG. 7. As can be seen in Table 1, when the reflective film 128 is disposed on the body portion 1231, the first reflective enhancing film 1141 is disposed near the body portion 1231, and a medium on a side of the reflective film 128 away from the body portion 1231 may be air. A total thickness of the reflective film 128 in the embodiment corresponding to Table 1 is 362.89 nm, and an increase in optical surface flatness (PV) is less than 0.052. In this way, while the reflectivity is improved, the thickness is small, a high flatness is achieved, and the reflected light has an improved quality.

TABLE 1

| | First reflective | | First | | Al | Second | | |
|---|---|---|---|---|---|---|---|---|
| Body | enhancement film | | protective film | | film | protection film | | |
| portion | SiO₂ | TiO₂ | SiO₂ | Al₂O₃ | Al | Al₂O₃ | SiO₂ | air |
| — | 75.01 nm | 52.97 nm | 51.5 nm | 30 nm | 100 nm | 30 nm | 23.41 nm | — |

As shown in FIGS. 2, 7, and Table 1, in some embodiments, the first protective film 1142 further includes a silicon dioxide layer disposed on a side of the aluminum oxide layer away from the Al film 1143. The second protective film 1144 may further include a silicon dioxide layer attached to the side of the aluminum oxide away from the Al film 1143. The silicon dioxide layer has sufficient structural strength and antioxidant performance to provide good protection for the Al film 1143 and enhance the structural strength of the reflective film 128. Furthermore, structural bonding between the silicon dioxide layer and the aluminum dioxide layer as well as between the aluminum dioxide layers is stronger than structural bonding between the silicon dioxide layer and the Al film 1143. By arranging the silicon dioxide layer and the aluminum dioxide layer, bonding between the silicon dioxide layer, the aluminum dioxide layer, and the Al film 1143 is tighter, such that the structural strength, the stability of the performance, and the service life of the reflective film 128 are improved. In addition, the silicon dioxide layer of the first protective film 1142 is adjacent to the titanium dioxide layer in the first reflective film 1141, and cooperation between the silicon dioxide layer and the titanium dioxide layer further enhances the reflectivity of the reflective film 128, such that the utilization of light is improved. In some embodiments, the three-layer structure of the aluminum dioxide layer, the Al film 1143, and the aluminum dioxide layer may be formed by oxidizing two sides of an aluminum material. An unoxidized portion of the aluminum material forms the Al film 1143, and oxidized portions at the two sides of the aluminum material form the two aluminum dioxide layers. In this way, the aluminum oxide layers are arranged on the aluminum film 1143, the structural strength of the aluminum oxide layers and the Al film 1143 is improved.

In some embodiments, a thickness of the silicon dioxide layer in the first protective film 1142 is less than a thickness of the silicon dioxide layer in the first reflective film 1141. The silicon dioxide layer in the first protective film 1142 protects the aluminum dioxide layer and improve the reflectivity. The first reflective film 1141, in combination with the titanium dioxide layer, further enhances the reflectivity. In this way, the thickness of the silicon dioxide layer in the first reflective film 1141 is greater than the thickness of the silicon dioxide layer in the first protective film 1142, such that a reflectivity enhancement effect of the first reflective film 1141 is improved, and the thickness of the silicon dioxide layer in the first protective film 1142 is prevented from being excessively large while providing the protection and enhancing the reflectivity, and therefore, the thickness of the reflective film 128 is reduced. In some embodiments, the thickness of the silicon dioxide layer in the second protective film 1144 is smaller than the thickness of the silicon dioxide layer in the first protective film 1142. In this way, while the second protective film 1144 provides sufficient protection to the Al film 1143, the second protective film 1144 does not have an excessively large size, and the thickness of the reflective film 128 is further reduced.

In some embodiments, a refractivity of the body portion 1231 is greater than or equal to 1.5 and less than or equal to 2. A reasonable configuration of the refractivity of the body portion 1231 allows the body portion 1231 and the reflective film 128 to cooperate with each other properly. By arranging a proper difference between the refractivity of the body portion 1231 and the refractivity of the reflective film 128, a reflectivity of light emitted from the body portion 1231 to reach the reflective film 128 is improved. In the embodiments corresponding to Table 1 and FIG. 3, the reflectivity of the body portion 1231 may be 1.52, and a material of the body portion 1231 may be H-K9L glass.

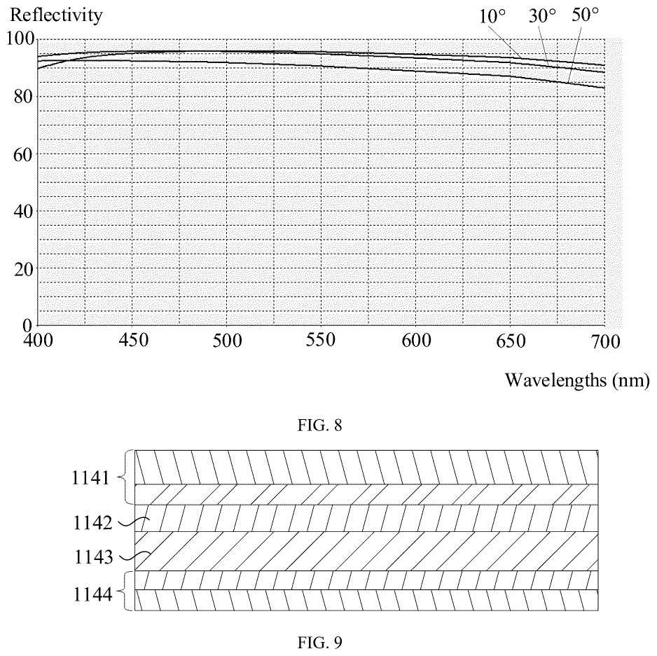

As shown in FIGS. 7 and 8, FIG. 8 shows a reflectivity curve of the reflective film 128 in the embodiment corresponding to Table 1. A horizontal axis represents wavelengths, a vertical axis represents the reflectivity. Three different curves respectively represent reflectivities in the following three cases. In a first case, the light has a light incidence angle of 10° on the reflective film 128; in a second case, the light has a light incidence angle of 30° on the reflective film 128; and in a third case, the light has a light incidence angle of 50° on the reflective film 128. As can be seen from FIG. 8, in a wavelength range of 400 nm-700 nm and when the light has the light incidence angle of 10° on the reflective film 128, the reflective film 128 has a maximum reflectivity of 95.9% (at 550 nm) and an average reflectivity of 94.35%. When the light has the light incidence angle of 50° on the reflective film 128, the reflective film 128 has a maximum reflectivity of 92.6% (at 435 nm) and an average reflectivity of 89.8%, and therefore, the light utilization rate is improved. Moreover, when the light has the light incidence angle of 10° to 50° on the reflective film 128, the reflectivity of the reflective film 128 is changed by less than 5%, a stable reflective performance is achieved, and the reflected light has high quality. In some embodiments, at a reference wavelength of 550 nm, the silicon dioxide layer has a refractivity of 1.46, the titanium dioxide layer has a refractivity of 2.45, and the aluminum oxide layer has a refractivity of 1.67.

In some embodiments, the thickness of the Al film 1143 is greater than or equal to 80 nm and less than or equal to 120 nm. In this way, the Al film 1143 has sufficient thickness to reflect the light, and the reflectivity of the reflective film 128 is improved. In addition, the thickness of the Al film 1143 is reduced, such that the thickness of the reflective film 128 is reduced. In some examples, the thickness of the silicon dioxide layer is greater than or equal to 12 nm and less than or equal to 200 nm, and the thickness of the titanium dioxide layer is greater than or equal to 6 nm and less than or equal to 150 nm. In this way, the thicknesses of the silicon dioxide layer and the titanium dioxide layer are not excessively small, enabling a process of preparing the silicon dioxide layer and the titanium dioxide layer to be performed easily. In addition, while the silicon dioxide layer and the titanium dioxide layer have enough thicknesses to enhance the reflectivity, the thicknesses of the silicon dioxide layer and the titanium dioxide layer are not excessively large, such that the thickness of the reflective film 128 is reduced.

As shown in Table 2 and FIG. 9 below, Table 2 and FIG. 9 corresponding to the reflective film 128 in some embodiments. In the embodiment corresponding to Table 2, the refractivity of the body portion 1231 may be 1.62, and the material of the body portion 1231 may be H-BAF6 glass. In this way, the body portion 1231 and the reflective film 128 may cooperate with each other properly, by properly configuring the difference between the refractivity between the body portion 1231 and the refractivity of the reflective film 128, an efficiency of light reflected from the body portion 1231 to the reflective film 128 is enhanced.

TABLE 2

| | First reflective | | First | | Second | | |
|---|---|---|---|---|---|---|---|
| | enhancement | | protective | Al | protective | | |
| Body | film | | film | film | film | | |
| portion | SIO₂ | TIO₂ | AL₂O₃ | AL | AL₂O₃ | SIO₂ | air |
| — | 86.26 | 53.01 | 74.2 | 100 | 30.4 | 35.2 | — |
| | nm | nm | nm | nm | nm | nm | |

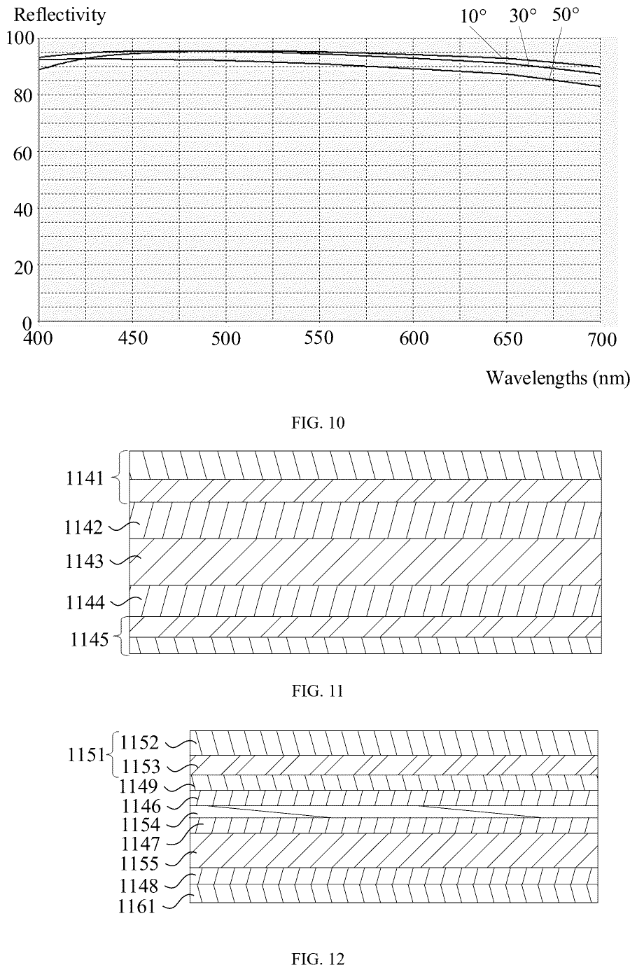

In the embodiments corresponding to Table 2 and FIG. 9, the silicon dioxide layer is not provided in the first protective film 1142, and the thickness of the aluminum dioxide layer in the first protective film 1142 may be greater than the thickness of the aluminum dioxide layer in the second protective film 1144. In this way, bonding strength between the first reflective enhancement film 1141 and the Al film 1143 is improved, structural strength of the reflective film is improved, and the reflectivity, in combination with the first reflective enhancement film 1141, is improved. As shown in FIGS. 9 and 10, in the embodiment corresponding to Table 2 and FIG. 9, the thickness of the reflective film 128 is 376.07 nm, an increase in the PV is less than 0.05λ. Therefore, the reflectivity is improved, the reflective film 128 has a small thickness and a high flatness, and the reflected light has improved quality. In the wavelength range of 400 nm-700 nm and when the light has the light incidence angle of 10° on the reflective film 128, the reflective film 128 has a maximum reflectivity of 95.5% (at 501 nm) and an average reflectivity of 93.8%. When the light has the light incidence angle of 50° on the reflective film 128, the reflective film 128 has a maximum reflectivity of 92.7% (at 435 nm) and an average reflectivity of 90%. Therefore, the reflective film 128 has improved reflectivity, light utilization of the image capturing module 12 is improved. In addition, when the light has the light incidence angle of 10° to 50° on the reflective film 128, the reflectivity of the reflective film 128 is changed by less than 5%, a stable reflective performance is achieved, and the reflected light has high quality.

As shown in FIGS. 2, 11, and Table 3 below, in another embodiment, the reflective film 128 further includes a second reflective enhancement film 1145 disposed on a side of the second protective film 1144 away from the Al film 1143. The second reflective enhancement film 1145 includes a silicon dioxide layer and a titanium dioxide layer disposed on a side of the silicon dioxide layer facing towards the second protective film 1144. Since the second reflective film 1145 is provided on the side of the second protective film 1144 facing away from the Al film 1143, the titanium dioxide layer and the silicon dioxide layer in the second reflective film 1145 cooperate with each other to enhance the reflectivity of the reflective film 128 to reflect light that is originated from a side of the reflective film 128 away from the body portion 1231 to reach the reflective film 128. It is understood that when the reflective film 128 is arranged on the body portion 1231 to form a reflective assembly, light reflected by the reflective film 128 needs to be detected to obtain parameters, such as the reflectivity, of the reflective film 128. However, when the detection is affected by factors such as light passing through the body portion 1231 to reach internal impurities, results of detecting the reflective film 128 may be inaccurate. Accordingly, in the embodiment shown in FIG. 11, the second reflective enhancement film 1145 is arranged on the side of the reflective film 128 away from the body portion 1231, and the reflective film 128 has improved reflectivity for the light which is reflected to the reflective film 128 from the side of the reflective film 128 away from the body portion 1231 (such as reflected from the air). Therefore, the light, which is reflected by the side of the reflective film 128 away from the body portion 1231, can be detected to obtain the parameter of the reflective film 128. An influence, caused by factors such as impurities of the body portion 1231, on the detection results is avoided, and accuracy of the detection can be improved.

TABLE 3

| | | | First | | second | | | |
|---|---|---|---|---|---|---|---|---|
| Body | First reflective | | protective | Al | protective | Second reflective | | |
| portion | enhancement film | | film | film | film | enhancement film | | |
| 1231 | SiO₂ | TiO₂ | Al₂O₃ | Al | Al₂O₃ | TiO₂ | SiO₂ | air |
| — | 86.26 nm | 53.01 nm | 74.2 nm | 150 nm | 71.98 nm | 49.3 nm | 20 nm | — |

In the embodiment corresponding to Table 3, the refractivity of the body portion 1231 may be 1.52, and the material of the body portion 1231 may be H-K9L glass. Therefore, the body portion 1231 and the reflective film 128 may cooperate with each other properly. By properly configuring the difference between the refractivity between the body portion 1231 and the refractivity of the reflective film 128, the reflectivity of light reflected from the body portion 1231 to the reflective film 128 is enhanced.

In some embodiments, a plurality of first reflective films 1141 are arranged. The plurality of first reflective films 1141 are sequentially laminated and arranged on a side of the first protective film 1142 away from the Al film 1143. Each of the plurality of first reflective films 1141 may include a silicon dioxide layer and a titanium dioxide layer. It can be understood that as the number of the first reflective films 1141 increases, the reflectivity of the reflective film 128 increases. The specific number of the first reflective films 1141 is not limited. For example, when the reflectivity of the reflective film 128 needs to be improved, the number of the first reflective films 1141 can be increased. When the reflectivity needs to be improved while the thickness of the reflective film 128 needs to be reduced, the number of the first reflective films 1141 can be reduced. Similarly, when the second reflective enhancement film 1145 is arranged on the side of the second protective film 1144 away from the Al film 1143, a plurality of second reflective enhancement films 1145 may be arranged to enhance the reflectivity of the reflective film 128, enabling the parameters of the reflective film 128 to be detected at the side of the reflective film 128 away from the body portion 1231.

In combination with FIGS. 2 and 12, in some embodiments, the reflective film 128 includes a first reflective enhancement film 1151, a silver film 1154, and an Al film 1155 that are sequentially provided. The first reflective enhancement film 1151 includes a silicon dioxide layer 1152 and a titanium dioxide layer 1153 disposed on a side of the silicon dioxide layer 1152 facing towards the silver film 1154. The silicon dioxide layer 1152 and the titanium dioxide layer 1153 in the first reflective film 1151 are disposed adjacent to and attached to each other.

For the above reflective film 128, the Al film 1155 is arranged to reflect light, and in addition, by arranging the silver film 1154 to cooperate with the aluminum film 1155, the reflectivity of the reflective film 128 to reflect the light is further improved. The titanium dioxide layer 1153 in the first reflective film 1151 of the reflective film 128 and the aluminum oxide layer cooperate with each other to improve the reflectivity of the reflective film 128 to reflect the light. The first reflective film 1151, the silver film 1154 and the aluminum film 1155 cooperate with each other to allow the reflective film 128 to reflect more light. For example, when the reflective film 128 is arranged on the first reflective surface 1232 and the second reflective surface 1233, the first reflective surface 1232 and the second reflective surface 1233 can reflect more light, the light utilization rate and the aperture of the image capturing module 12 are improved, a loss of light on the reflective film 128 is reduced, and the imaging quality of the image capturing module 12 is improved. In addition, the silicon dioxide layer 1152 in the first reflective film 1151 provides protection on the titanium dioxide layer 1153, such that performance stability and structural strength of the reflective film 128 are improved.

The layered structure of the reflective film 128 in some embodiments and the thickness of each layer of the layered structure are given in Tables 4A and 4B below. The reflective film 128 shown in Tables 4A and 4B corresponds to the reflective film 128 in the embodiment shown in FIG. 12. As can be seen from Tables 4A and 4B, when the reflective film 128 is arranged on the body portion 1231, the first reflective enhancement film 1151 is disposed near the body portion 1231, a medium on a side of the reflective film 128 is the body portion 1231, and a medium on the side of the reflective membrane 128 away from the body portion 1231 may be air.

TABLE 4A

| | | | First | First | |
|---|---|---|---|---|---|
| | First reflective | | protective | oxide | Silver |
| Body | enhancement film | | film | film | film |
| portion | SIO₂ | TIO₂ | SIO₂ | AL₂O₃ | Ag |
| — | 69.0 nm | 47.69 nm | 24.58 nm | 30 nm | 20 nm |

TABLE 4B

| | second | | Third | second | |
|---|---|---|---|---|---|
| | protective | Al | protective | protective | |
| Body | film | film | film | film | |
| portion | AL₂O₃ | AL | AL₂O₃ | SIO₂ | air |
| — | 30 nm | 100 nm | 30 nm | 37.94 nm | — |

As shown in Tables 4A, 4B and FIG. 12, in some embodiments, the reflective film 128 further includes a first oxide film 1146 disposed between the first reflective enhancement film 1151 and the silver film 1154; a second oxide film 1147 disposed between the silver film 1154 and the aluminum film 1155; and a third oxide film 1148 disposed on a side of the Al film 1155 away from the silver film 1154. Materials of the first oxide film 1146, the second oxide film 1147, and the third oxide film 1148 include, but are limited to, one or more metal oxides, such as aluminum oxide (Al₂O₃). By arranging oxide films respectively on two sides of the silver film 1154 and on two sides of the aluminum film 1155, the oxide films can protect the silver film 1154 and the aluminum film 1155 from being oxidized by air and affecting the reflectivity, such that stability of the performance of the reflective film 128 is improved. It is understood that when the second oxide film 1147 and the third oxide film 1148 are both made of aluminum oxide, in some embodiments, a three-layer structure of the second oxide film 1147, the aluminum film 1155, and the third oxide film 1148 may be formed by oxidizing two sides of an aluminum material. An unoxidized portion of the aluminum material forms the aluminum film 1155, and oxidized portions at the two sides of the aluminum material respectively form the second oxide film 1147 and the third oxide film 1148. In this way, the second oxide film 1147 and the third oxide film 1148 are arranged on the aluminum film 1155, bonding strength between the second oxide film 1147, the third oxide film 1148 and the aluminum film 1155 can be enhanced, and performance stability and structural strength of the reflective film 128 are improved.

Further, in some embodiments, the reflective film 128 further includes a first protective film 1149 disposed between the first reflective enhancement film 1151 and the first oxide film 1146, and a second protective film 1161 disposed on a side of the third oxide film 1148 away from the aluminum film 1155. Materials of the first oxide film 1146 and the third oxide film 1148 are aluminum oxide. Materials of the first protective film 1149 and the second protective film 1161 are both silicon dioxide. The first oxide film 1146 and the first protective film 1149 are adhered to each other, and the third oxide film 1148 and the second protective film 1161 are adhered to each other. The layered structure of the silicon dioxide and the layered structure of the aluminum oxide have good bonding strength. By disposing the first protective film 1149 between the first reflective enhancement film 1151 and the first oxide film 1146, bonding strength between the first reflective enhancement film 1151 and the first oxide film 1146 can be improved by the first protective film 1149. In addition, the first protective film 1149 includes the silicon dioxide, such that the silicon dioxide and the titanium dioxide layer 1153 may be arranged alternately to further improve the reflectivity of the reflective film 128. By arranging the second protective film 1161 with the aluminum film 1155 and the third oxide film 1148 to form a three-layer structure of aluminum-aluminum oxide-silicon oxide, bonding strength between adjacent two layers is improved, and the structural strength of the reflective film 128 is improved.

As shown in Tables 4A, 4B and FIG. 12, in some embodiments, when the materials of the first protective film 1149 and the second protective film 1161 include silicon oxide, the thickness of the second protective film 1161 is greater than the thickness of the first protective film 1149 and less than the thickness of the silicon oxide layer 1152 in the first reflective enhancement film 1151. In this way, the silicon oxide layer 1152 has sufficient thickness to cooperate with the titanium dioxide layer 1153 to enhance the reflectivity of the reflective film 128. In addition, the titanium dioxide layer 1153 is protected, and the structural strength of the reflective film 128 is improved. The first protective film 1149 protects the first oxide film 1146, improves the bonding strength of the first oxide film 1146, and has a sufficiently small size, such that the thickness of the reflection film 128 is reduced. In addition, the second protective film 1161 has sufficient strength to protect the third oxide film 1148 and enhance the structural strength of the reflective film 128, and the thickness of the second protective film 1161 is not excessively large, such that the thickness of the reflection film 128 is reduced.

In some embodiments, the refractivity of the body portion 1231 is greater than or equal to 1.5 and less than or equal to 2. By configuring a proper refractivity for the body portion 1231, the body portion 1231 and the reflective film 128 may cooperate with each other properly. By properly configuring the difference between the refractivity between the body portion 1231 and the refractivity of the reflective film 128, the reflectivity of light reflected from the body portion 1231 to the reflective film 128 is enhanced. In the embodiment corresponding to Table 4 and FIG. 12, the refractivity of the body portion 1231 may be 1.52, and the material of the body portion 1231 may be H-K9L glass.

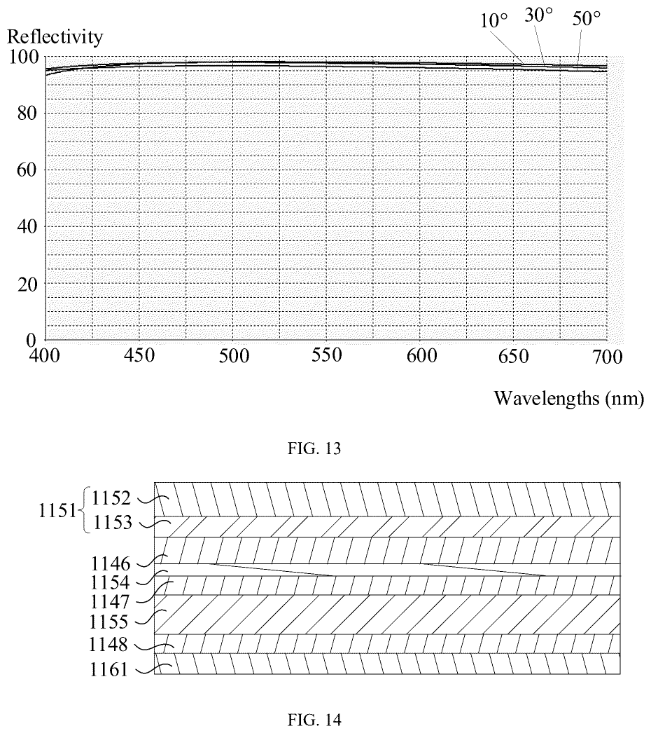

As shown in FIG. 12 and FIG. 13, FIG. 13 shows reflectivity curves of the reflective film 128 in the embodiment corresponding to Tables 4A, 4B and FIG. 12. A horizontal axis indicates wavelengths, and a vertical axis indicates the reflectivity. Three different curves respectively represent reflectivities in the following three cases. In a first case, the light has the light incidence angle of 10° on the reflective film 128; in a second case, the light has the light incidence angle of 30° on the reflective film 128; and in a third case, the light has the light incidence angle of 50° on the reflective film 128. As can be seen from Table 4 and FIG. 13, the total thickness of the reflective film 128 is 389.2 nm, and an increase in the optical surface flatness (PV) of the reflective film 128 is less than 0.052. Therefore, the reflectivity is increased, the reflective film has a small thickness and high flatness, and the reflected light is in high quality. In a wavelength range of 400 nm-700 nm and when the light has the light incidence angle of 10° on the reflective film 128, the reflective film 128 has a maximum reflectivity of 98% (at 509 nm) and an average reflectivity of 97.3%. In the wavelength range of 400 nm-700 nm and when the light has the light incidence angle of 50° on the reflective film 128, the reflective film 128 has a maximum reflectivity of 96.7% (at 435 nm) and an average reflectivity of 96%, and therefore, the light utilization rate is improved.

Moreover, when the light has the light incidence angle of 10° to 50° on the reflective film 128, the reflectivity of the reflective film 128 is changed by less than 2%, a stable reflective performance is achieved, and the reflected light has high quality. In some embodiments, at a reference wavelength of 550 nm, each of a refractivity of the silicon dioxide layer 1152, a refractivity of the first protective film 1149, and a refractivity of the second protective film 1161 is 1.46, a refractivity of the titanium dioxide layer 1153 is 2.45; and each of a refractivity of the first oxide film 1146, a refractivity of the second oxide film 1147, and a refractivity of the third oxide film 1148 is 1.67.

In some embodiments, the thickness of the Al film 1155 is greater than or equal to 80 nm and less than or equal to 120 nm, and the thickness of the silver film 1154 is greater than or equal to 10 nm and less than or equal to 50 nm. Therefore, each of the Al film 1155 and the silver film 1154 to has a sufficient thickness to reflect the light to enhance the reflectivity of the reflective film 128, and the thicknesses of the aluminum film 1155 and the silver film 1154 are reduced, such that the thickness of the reflective film 128 is reduced. In some examples, the thickness of the silicon dioxide layer 1152 is greater than or equal to 12 nm and less than or equal to 200 nm, and the thickness of the titanium dioxide layer 1153 is greater than or equal to 6 nm and less than or equal to 150 nm. In this way, thicknesses of the silicon dioxide layer 1152 and the titanium dioxide layer 1153 are not excessively small, such that the silicon dioxide layer 1152 and the titanium dioxide layer 1153 can be prepared easily. In addition, while each of the silicon dioxide layer 1152 and the titanium dioxide layer 1153 has the sufficient thickness to improve the reflectivity, thicknesses of the silicon dioxide layer 1152 and the titanium dioxide layer 1153 are not excessively large, such that the thickness of the reflective film 128 is reduced. In some embodiments, each of the thickness of the first protective film 1149 and the thickness of the second protective film 1161 may be 12 nm-200 nm, which may be determined according to the requirements for the reflectivity and the thickness, and will not be limited herein.

As shown in Table 5 and FIG. 14, Table 5 and FIG. 14 correspond to the reflective film 128 in some other embodiments, the refractivity of the body portion 1231 may be 1.62, and the material of the body portion 1231 may be H-BAF6 glass, such that the body portion 1231 and the reflective film 128 may cooperate with each other properly, by properly configuring the difference between the refractivity between the body portion 1231 and the refractivity of the reflective film 128, the reflectivity of light reflected from the body portion 1231 to the reflective film 128 is enhanced.

TABLE 5

| | First reflective | | First | | Second | | Third | Second | |
|---|---|---|---|---|---|---|---|---|---|
| | enhancement | | oxide | Silver | oxide | Al | oxide | protective | |
| Body | film | | film | film | film | film | film | film | |
| portion | SiO₂ | TiO₂ | Al₂O₃ | Ag | Al₂O₃ | Al | Al₂O₃ | SiO₂ | air |
| — | 70.32 nm | 48.59 nm | 50.69 nm | 15 nm | 30 nm | 59.63 nm | 30.9 nm | 36.93 nm | — |

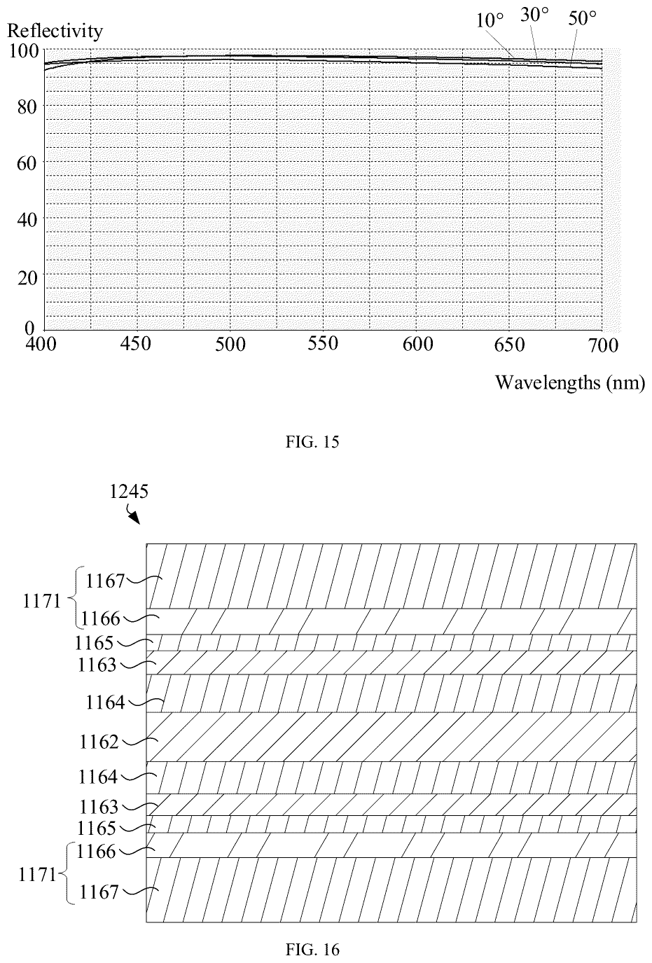

In the embodiments corresponding to Table 5 and FIG. 14, the first protective film 1149 may be omitted, and the thickness of the first oxide film 1146 may be greater than the thickness of the second oxide film 1147 and the thickness of the third oxide film 1148. In this way, bonding strength between the first reflective enhancement film 1151 and the first oxide film 1146 is improved, structural strength of the reflective film 128 is improved, and the first oxide film 1146 has a have sufficient thickness to cooperate with the first reflective enhancement film 1151 to improve the reflectivity. As shown in FIGS. 14 and 15, in the embodiment corresponding to Table 5 and FIG. 14, the thickness of the reflective film 128 is 340.84 nm, an increase in the PV of the reflective film 128 is less than 0.05λ. Therefore, the reflectivity is improved, the reflective film 128 has a small thickness and a high flatness, and the reflected light are in good quality. In a wavelength range of 400 nm-700 nm and when the light has the light incidence angle of 10° on the reflective film 128, the reflective film 128 has a maximum reflectivity of 97.6% (at 505 nm) and an average reflectivity of 96.7%. In the wavelength range of 400 nm-700 nm and when the light has the light incidence angle of 50° on the reflective film 128, the reflective film 128 has a maximum reflectivity of 96.2% (at 500 nm) and an average reflectivity of 95.2%, and therefore, the reflective film 128 has improved reflectivity, light utilization of the image capturing module 12 is improved. In addition, when the light has the light incidence angle of 10° to 50° on the reflective film 128, the reflectivity of the reflective film 128 is changed by less than 2%, a stable reflective performance is achieved, and the reflected light has high quality.

Further, in some embodiments, the reflective film 128 further includes a second reflective enhancement film (not shown) disposed on a side of the aluminum film 1155 away from the silver film 1154, and the second reflective enhancement film may include a silicon dioxide sub-layer and a titanium dioxide sub-layer arranged on a side of the silicon dioxide sub-layer facing towards the aluminum film 1155. The second reflective film is disposed on the side of the aluminum film 1155 away from the silver film 1154, and similar to the first reflective film 1151, the titanium dioxide sub-layer and the silicon dioxide sub-layer in the second reflective film cooperate with each other to enhance the reflectivity of the reflective film 128 to reflect light from the side of the reflective film 128 away from the body portion 1231 to the reflective film 128.

It is to be understood that when the reflective film 128 is disposed on the body portion 1231 to enable the reflective film 128 and the body portion 1231 to cooperatively form a reflective assembly, light reflected by the reflective film 128 needs to be detected in order to obtain parameters such as the reflectivity of the reflective film 128. However, when detecting light, which passes through the body portion 1231 to reach the reflective film 128 and is reflected by the reflective film 128 to emit to reach the body portion 1231, internal impurities in the body portion 1231 may affect the detection, results of detecting the reflective film 128 may be inaccurate. Accordingly, in the embodiment, the second reflective enhancement film is arranged on the side of the reflective film 128 away from the body portion 1231, and the reflective film 128 has improved reflectivity for the light which is reflected to the reflective film 128 from the side of the reflective film 128 away from the body portion 1231 (such as reflected from the air). Therefore, the light, which is reflected by the side of the reflective film 128 away from the body portion 1231, can be detected to obtain the parameter of the reflective film 128. An influence, caused by factors such as impurities of the body portion 1231, on the detection results is avoided, and accuracy of the detection can be improved. It is to be noted that when the reflective film 128 is arranged with the second protective film 1161 made of silicon dioxide, the second reflective film may be disposed on the side of the second protective film 1161 away from the aluminum film 1155, and the titanium dioxide sub-layer in the second reflective film is attached to the second protective film 1161. In this way, the titanium dioxide sub-layer and the second protective film 1161 may cooperate each other to improve the reflectivity of the reflective film 128 of reflecting light that reaches the side of the reflective film 128 away from the body portion 1231.

In some embodiments, a plurality of first reflective film 1151 arranged and are sequentially laminated on a side of the first protective film 1149 away from the silver film 1154. Each of the plurality of first reflective films 1151 may include a silicon dioxide layer 1152 and a titanium dioxide layer 1153. It is understood that as the number of the first reflective films 1151 increases, the reflectivity of the reflective film 128 increases. The specific number of the first reflective films 1151 is not limited herein. For example, when the reflectivity of the reflective film 128 needs to be improved, the number of the first reflective films 1151 can be increased, and for the plurality of first reflective films 1151, a plurality of silicon dioxide layers 1152 and a plurality of titanium dioxide layer 1153 are arranged alternately, such that the reflectivity is improved. When the thickness of the reflective film 128 needs to be reduced while the reflectivity is improved, the number of the first reflective films 1151 can be reduced. Similarly, when the second reflective enhancement film is arranged on the side of the second protective film 1161 away from the aluminum film 1155, a plurality of second reflective films may be arranged to enhance the reflectivity of the reflective film 128, such that the parameter of the reflective film 128 can be detected from the side of the reflective film 128 away from the body portion 1231.

As shown in FIGS. 2 and 16, in some embodiments, the second light absorbing film 1245 includes a first titanium film layer 1162 and two reflection-reducing film layers 1171. The two reflection-reducing film layers 1171 are respectively disposed on two sides of the first titanium film layer 1162. Each of the two reflection-reducing film layers 1171 includes a titanium dioxide layer 1166 and a silicon dioxide layer 1167, and the titanium dioxide layer 1166 and the silicon dioxide layer 1167 in each reflection-reducing film layer 1171 are disposed adjacent to and attached to each other.

For the above second light absorbing film 1245, the first titanium film layer 1162 is arranged to absorb light, such that light transmittance and reflectivity of the second light absorbing film 1245 are reduced. By arranging the two reflection-reducing film layers 1171 respectively at the two sides of the first titanium film layer 1162, the titanium dioxide layer 1166 and silicon dioxide layer 1167, which are arranged in each of the two reflection-reducing film layers 1171 and are adjacent to each other, can reduce the reflectivity of the second light absorbing film 1245. Therefore, when the second light absorbing film 1245 serves as a light shielding element in the light propagating path, the light can be effectively absorbed and reflection of the light on the second light absorbing film 1245 can be reduced. In this way, the stray light and the interfering light in the light propagating path is reduced, glaring and halo in imaging can be reduced, and the imaging quality based on the light passing through the second light absorbing film 1245 can be improved. In addition, by arranging the first titanium film layer 1162 to cooperate with the reflection-reducing film layer 1171, a light shielding effect is improved, the thickness of the second light absorbing film 1245 is reduced compared to taking the ink as the light shielding element in the art. Therefore, when the second light absorbing film 1245 is glued to the first sub-prism 1241 and the second sub-prism 1242 through the optical glue, a significant height difference may not be generated due to the optical glue arranged on the second light absorbing film 1245 and a region where no second light absorbing film 1245 is arranged. In this way, air bubbles can be prevented in the optical glue, and the optical glue is prevented from being unevenly distributed, such that the imaging quality is not affected.

Table 6 below illustrates a layered structure of the second light absorbing film 1245 and a thickness of each layer in the layered structure in some embodiments. When the second light absorbing film 1245 is disposed between the first sub-prism 1241 and the second sub-prism 1242, media on two sides of the second light absorbing film 1245 may be the first sub-prism 1241 and the second sub-prism 1242, respectively. The light emitted from the lens 111 reaches the first sub-prism 1241 and passes through the second light absorbing film 1245 disposed between the first sub-prism 1241 and the second sub-prism 1242 to further reach the second sub-prism 1242. As can be seen in Table 6, the total thickness of the second light absorbing film 1245 is 774.48 nm, which is much smaller than the thickness of an ink layer as the light shielding element. In this way, the height difference between the optical glue, which is disposed between the first sub-prism 1241 and the second sub-prism 1242, and the region where no second light absorbing film 1245 is arranged is reduced, air bubbles can be prevented in the optical glue, and the optical glue is prevented from being unevenly distributed, such that the imaging quality is not affected.

TABLE 6

| | First sub-prism | — | |
|---|---|---|---|
| Reflection-reducing film layer | SiO₂ | 177.71 | nm |
| | TiO₂ | 20.32 | nm |
| Second protective film layer | SiO₂ | 12 | nm |
| Second Ti film layer | Ti | 21.3 | nm |
| First protective film layer | SiO₂ | 80.01 | nm |
| first Ti film layer | Ti | 150 | nm |
| first protective film layer | SiO₂ | 80.01 | nm |
| Second Ti film layer | Ti | 21.3 | nm |
| second protective film layer | SiO₂ | 12 | nm |
| Reflection-reducing film layer | TiO₂ | 20.32 | nm |
| | SiO₂ | 177.71 | nm |
| | Second sub-prism | | |

As shown in FIG. 16 and Table 6, in some embodiments, the second light absorbing film 1245 further includes two first protective film layers 1164. The two first protective film layers 1164 are respectively disposed on two sides of a first titanium film layer 1162 and are both disposed between the first titanium film layer 1162 and the reflection-reducing film layer 1171. The two first protective film layers 1164 provides protection for the first titanium film layer 1162, protecting the first titanium film layer 1162 from being oxidized, such that the reflectivity is not affected, and performance stability and the service life of the second light absorbing film 1245 are improved. In some embodiments, a material of the first protective film layer 1164 may be metal oxide, and the metal oxide has good antioxidant performance and can effectively prevent the first titanium film layer 1162 from being oxidized. For example, in some embodiments, the material of the first protective film layer 1164 may be silicon dioxide. The silicon dioxide can protect the first titanium film layer 1162 and can also be tightly bonded with the first titanium film layer 1162 to enhance the structural stability and the service life of the second light absorbing film 1245.

In some embodiments, the second light absorbing film 1245 further includes two second titanium film layers 1163, and the two second titanium film layers 1163 are respectively disposed on two sides of the first titanium film layer 1162 and are both disposed between the first protective film layer 1164 and the reflection-reducing film layer 1171. The second titanium film layer 1163 is arranged to cooperate with the first titanium film layer 1162 to effectively improve reflectivity and light transmittance of the second light absorbing film 1245. In addition, the second titanium film layer 1163 is disposed adjacent to and adhered to the first protective film layer 1164, such that the second titanium film layer 1163 and the silicon dioxide of the first protective film layer 1164 cooperate with each other to effectively reduce the reflectivity of the second light absorbing film 1245 to reduce the stray light in the image capturing module 12.

In some embodiments, a thickness of the second titanium film layer 1163 is smaller than a thickness of the first titanium film layer 1162. In this way, while the second titanium film layer 1163 effectively reduces the reflectivity of the second light absorbing film 1245, the thickness of the second light absorbing film 1245 is also reduced, the image capturing module 12 occupies a smaller space. Therefore, the risk of having air bubbles due to the height difference, caused by the optical glue, between the first sub-prism 1241 and the second sub-prism 1242 can be reduced, the imaging quality of the image capturing module 12 can be improved.

In some embodiments, the second light absorbing film 1245 further includes two second protective film layers 1165, the two second protective film layers 1165 are disposed on two sides of the first titanium film layer 1162 and are both disposed between the reflection-reducing film layer 1171 and the second titanium film layer 1163. A material of the second protective film layer 1165 may be metal oxide, such as silicon dioxide. The second protective film layer 1165 is disposed adjacent to and adhered to the titanium dioxide layer 1166 and the second titanium film layer 1163. The second protective film layer 1165 is arranged to protect the second titanium film layer 1163, preventing the second titanium film layer 1163 from being oxidized, such that a light shielding effect, performance stability, and the service life of the second light absorbing film 1245 are improved. In addition, the silicon dioxide of the second protective film layer 1165 and the titanium dioxide layer 1166 in the reflection-reducing film layer 1171 are attached to each other, such that the titanium dioxide layer 1166 and the second protective film layer 1165 can cooperate with each other to improve a reflection-reducing effect of the second light absorbing film 1245, the stray light in the image capturing module 12 is reduced, and the imaging quality is improved.

Further, in some embodiments, the thickness of the silicon layer 1167 is greater than the thickness of the first protective film layer 1164. The thickness of the first protective film layer 1164 is greater than the thickness of the second protective film layer 1165. Therefore, the first protective film layer 1164 has a sufficient thickness to cooperate with the first titanium film layer 1162 and the second titanium film layer 1163 to reduce the reflectivity and light transmittance of the second light absorbing film 1245 and to improve the light-shielding effect. The large thickness of the first protective film layer 1164 enables light to properly transit between the first titanium film layer 1162 and the second titanium film layer 1163, such that the second light absorbing film 1245 have stable reflectivity and light transmittance for light in various wavelengths, such that stability of the performance of the second light absorbing film 1245 for various spectral light is improved. The second protective film layer 1165 effectively protects the second titanium film layer 1163, and the thickness of second protective film layer 1165 is not excessively large, such that the thickness of the second light absorbing film 1245 is reduced. In addition, the silicon dioxide layer 1167, as an outermost layer of the second light absorbing film 1245, has a sufficient thickness to protect various layers in the second light absorbing film 1245, improving the structural strength of the second light absorbing film 1245. In addition, the light can transit properly in the silicon dioxide layer 1167, the second light absorbing film 1245 have stable reflectivity and light transmittance for light in various wavelengths, stability of the performance of the second light absorbing film 1245 for various spectral light is improved.

In some embodiments, the thickness of the first titanium film layer 1162 is greater than or equal to 100 nm, and is less than or equal to 200 nm. For example, the thickness of the first titanium film layer 1162 may be 150 nm. The first titanium film layer 1162 has a sufficient thickness to absorb light so as to improve a light absorbing capacity of the second light absorbing film 1245, such that the second light-absorbing film 1245 can efficiently absorb stray light to improve the imaging quality. In some embodiments, the thickness of the silica layer 1167 is greater than or equal to 50 nm and less than or equal to 200 nm, such as 177.71 nm, so as to improve the structural strength of the second light absorbing film 1245 and to improve the stability of the performance of the second light absorbing film 1245 for various spectral light. When each of the material of the first protective film layer 1164 and the material of the second protective film layer 1165 is a silicon dioxide layer 1167, the thickness of the first protective film layer 1164 and the thickness of the second protective film layer 1165 may be greater than or equal to 12 nm and less than or equal to 200 nm. In some embodiments, the thickness of the titanium dioxide layer 1166 is greater than or equal to 6 nm and less than or equal to 150 nm. The thickness of the titanium dioxide layer 1166 may be determined according to the reflection-reducing effect and the structural strength of the second light absorbing film 1245, which will not be discussed herein.

In some embodiments, each of the refractivity of the first sub-prism 1241 and the refractivity of the second sub-prism 1242 of the optical conduction element 113 is greater than or equal to 1.5 and less than or equal to 2. By properly configuring the refractivity of the optical conduction element 113, the optical conduction element 113 and the second light absorbing film 1245 may cooperate with each other. By properly configuring the difference between the refractivity between the second light absorbing film 1245 and the refractivity of the optical conduction element 113, the reflectivity and the light transmittance of the second light absorbing film 1245 for the light, which is emitted from the optical conduction element 113 to the second light absorbing film 1245, can be reduced. In the embodiments corresponding to Table 6 and FIG. 16, the refractivity of the optical conduction element 113 may be 1.62, and the material of the optical conduction element 113 may be H-BAF6 glass.

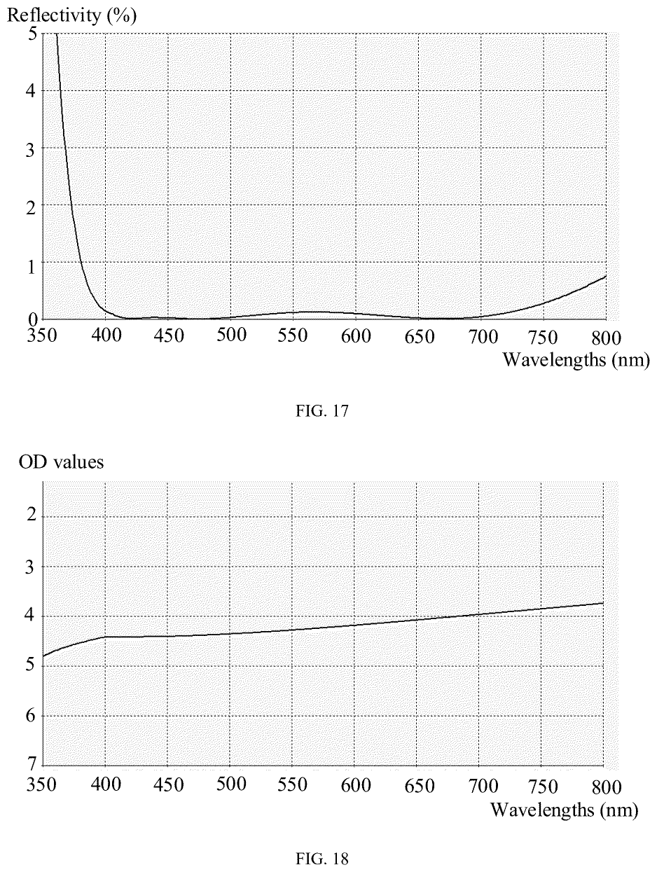

As shown in FIG. 16, FIG. 17 and FIG. 18, FIG. 17 shows a reflectivity curve of the second light absorbing film 1245 in some embodiments, where a horizontal axis represents wavelengths, and a vertical axis represents the reflectivity. FIG. 18 shows a curve of Optical Density (OD) values of the second light absorbing film 1245 in some embodiments, where a horizontal axis represents wavelengths, and a vertical axis represents OD values. Based on FIG. 17 and FIG. 18, a highest reflectivity of the second light absorbing film 1245 for reflecting light at wavelengths of 400 nm-700 nm is 0.14% (at 400 nm), and an average reflectivity is 0.05%. The reflectivity of the second light absorbing film 1245 for reflecting light is sufficiently low, the second light absorbing film 1245 can effectively absorb light, and reflection of the light on the second light absorbing film 1245 is reduced, such that the stray light component in the image capturing module 12 is reduced, and the imaging quality is improved. In addition, the second light absorbing film 1245 has a maximum OD value of 4.4 (at 414 nm) and an average OD value of 4.3 for light at wavelengths of 400 nm-700 nm. The second light absorbing film 1245 has a sufficiently low light transmittance to effectively absorb the light, such that the stray light in the image capturing module 12 is reduced, glaring and halo can be reduced, and the imaging quality is improved.

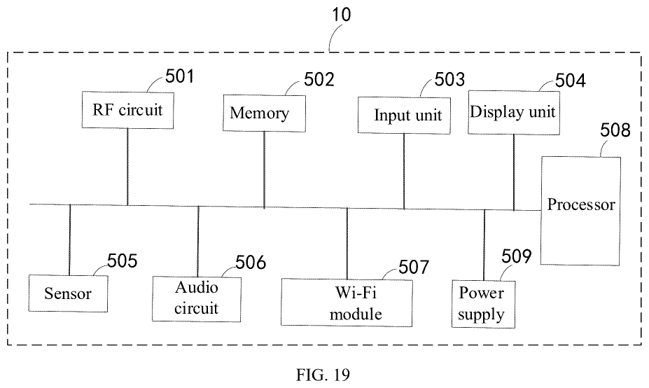

As shown in FIG. 19, FIG. 19 is a structural schematic view of the electronic device 10 according to an embodiment of the present disclosure. The electronic device 10 may include a radio frequency (RF) circuit 501, a memory 502 including one or more computer-readable storage media, an input unit 503, a display unit 504, a sensor 505, an audio circuit 506, a wireless fidelity (Wi-Fi) module 507, a processor 508 including one or more processing cores, and a power supply 509. Any ordinary skilled person in the art shall understand that the structure of the electronic device 10 illustrated in FIG. 19 does not limit the electronic device 10, and the electronic device 10 may include more or fewer components than illustrated, or include combinations of certain components, or the components may be arranged in a different manner.

The RF circuit 501 is configured to send and receive information, or receive and send signals during a call, and in particular, receive downlink information from a base station and forward the downlink information to one or more processors 508 for processing. In addition, the RF circuit 501 is configured to send uplink data to the base station. Typically, the RF circuit 501 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 501 can communicate with networks and other devices via wireless communication. The wireless communication may use any communication standard or protocol including, but not limited to, global system of mobile communication (GSM), general packet radio service (GPRS), code division multiple access (CDMA), wideband code division multiple access (WCDMA), long term evolution (LTE), e-mail, short messaging service (SMS) and so on.

The memory 502 may be configured to store application programs and data. The application programs stored in the memory 502 include executable codes. The application programs may form various functional modules. The processor 508 performs various functional applications and data processing by running the application programs stored in the memory 502. The memory 502 may include a storage program area and a storage data area. The storage program area may store an operating system, an application program required for achieving at least one function (such as a sound playing function, an image displaying function, and so on). The storage data area may store data (such as audio data, a contact list, and so on) that are created during the electronic device 10 being in use. In addition, the memory 502 may include a high-speed random access memory, and may further include a non-volatile memory, such as at least one disk memory device, a flash memory device, or other volatile solid state memory device. Accordingly, the memory 502 may further include a memory controller to provide access to the memory 502 by the processor 508 and the input unit 503.

The input unit 503 may be configured to receive input numbers, character information, or user characteristic information (such as fingerprints), and configured to generate a keyboard signaling input, a mouse signaling input, a joystick signaling input, an optical signaling input, or a trackball signaling input related to user settings and function control. Specifically, in an embodiment, the input unit 503 may include a touch-sensing surface and other input devices. The touch-sensing surface, also referred to as a touch display or a touchpad, may collect touch operations performed by a user on or performed nearby (such as operations performed by a user on or near the touch-sensing surface using a finger, a stylus, or any other suitable object or accessory) and actuate a corresponding connected device according to a predetermined program. In some embodiments, the touch-sensing surface may include two parts, a touch detection device and a touch controller. The touch detection device detects an orientation of a touch from the user and detects a signal brought about by the touch operation, and transmits the signal to the touch controller. The touch controller receives touch information from the touch detection device and converts the touch information into contact coordinates, and then sends the contact coordinates to the processor 508, and can receive commands from the processor 508 and execute the commands.

The display unit 504 may be configured to display information entered by or provided to the user and display various graphical user interfaces of the electronic device 10. The graphical user interfaces may be formed by graphics, texts, icons, videos, and any combination thereof. The display unit 504 may comprise a display panel. In some embodiments, the display panel may be configured as a liquid crystal display (LCD), an organic light-emitting diode (OLED), or the like. Further, the touch-sensing surface may cover the display panel. When the touch-sensing surface detects the touch operation performed on or near the touch-sensing surface, the touch-sensing surface transmits the touch operation to the processor 508 to determine a type of touch event, and the processor 508 subsequently provides a corresponding visual output on the display panel based on the type of touch event. Although in FIG. 19, the touch-sensing surface and the display panel are configured as two separated components to achieve the input and output functions, in some embodiments, the touch-sensing surface and the display panel may be integrated together to achieve the input and output functions. It is understood that the display 110 may include an input unit 503 and a display unit 504.

The electronic device 10 may further include at least one sensor 505, such as a light sensor, a motion sensor, and other sensors. Specifically, the light sensor may include an ambient light sensor and a proximity sensor. The ambient light sensor may adjust brightness of the display panel based on brightness of the ambient light, and the proximity sensor may turn off the display panel and/or a backlight when the electronic device 10 is moved to an ear. As a kind of motion sensor, a gravity acceleration sensor can detect a magnitude of acceleration in each direction (generally in three axes), and the magnitude and the direction of gravity can be detected, when stationary. The magnitude and the direction of gravity may be used for: applications for recognizing a posture of the mobile phone (such as portrait and landscape screen switching, related games, magnetometer posture calibration); functions relate to vibration recognition (such as pedometer, tapping), and so on. The electronic device 10 may further be configured with a gyroscope, a barometer, a hygrometer, a thermometer, an infrared sensor and other sensors, which will not be described herein.

The audio circuit 506 may provide an audio interface between the user and the electronic device 10 via a speaker and a microphone. The audio circuit 506 may convert received audio data into electrical signals to be transmitted to the speaker, the speaker converts the electrical signals into sound signals to be output. On the other hand, the microphone converts the received sound signals into electrical signals, the electrical signals are received by the audio circuit 506 and are converted into audio data. The audio data are processed by the audio data output processor 508 to be transmitted via the radio frequency circuit 501 in order to be sent to, for example, another electronic device 10; or the audio data are output to the memory 502 for further processing. The audio circuit 506 may further include a headphone holder to provide communication between a peripheral headphone and the electronic device 10.

The Wireless fidelity (Wi-Fi) is a short-range wireless transmission technology. The electronic device 10 can assist users send and receive e-mails, browse a web, and access streaming media through the wireless fidelity module 507. The wireless fidelity module 507 provides the user with wireless access to a broadband Internet. Although the wireless fidelity module 507 is illustrated in FIG. 19, it is understood that the wireless fidelity module 507 is not a mandatory component of the electronic device 10 and can be omitted as long as the essence of the present disclosure is not changed.

The processor 508 is a control center of the electronic device 10 and is connected to various components of the electronic device 10 using various interfaces and lines. The processor 508 performs various functions of the electronic device 10 and processes data by running or executing an application program stored in the memory 502 and by invoking data stored in the memory 502, so as to monitor the electronic device 10 as a whole. In some embodiments, the processor 508 may include one or more processing core. In some embodiments, the processor 508 may integrate an application processor and a modem processor. The application processor mainly runs the operating system, the user interface, the application programs, and so on. The modem processor mainly performs the wireless communication. It is understood that the modem processor described above may alternatively not be integrated into the processor 508.

The electronic device 10 further includes a power supply 509 that supplies power to the various components. In some embodiments, the power supply 509 may be logically connected to the processor 508 via a power management system, so as to manage charging, discharging, and power consumption. The power supply 509 may further include one or more DC or AC power sources, a re-charging system, a power failure detection circuit, a power converter or inverter, a power status indicator, and any other component.

Although not shown in FIG. 19, the electronic device 10 may further include a Bluetooth module, which will not be described herein. In a specific implementation, each of the above modules may be configured as an independent entity, or may be combined in any manner as a same entity or several entities. The specific implementation of each of the above modules may be referred to the above embodiments, and will not be repeated herein.

The various technical features of the above-described embodiments can be combined in any manner, and all possible combinations of the various technical features of the above-described embodiments are not described in order to make the description concise. However, as long as there is no contradiction in combination, any combined technical solution shall be considered as being within the scope of the present disclosure.

The above-described embodiments show only several embodiments of the present disclosure, which are described in a more specific and detailed manner, but shall not be construed as a limitation of the scope of the patent disclosure. It should be noted that, any ordinary skilled person in the art may perform deformations and improvements without departing from the concept of the present disclosure, and the deformations and improvements shall fall within the scope of the present disclosure. Therefore, the scope of the present disclosure shall be subject to the attached claims.

What is claimed is:

1. An optical conduction element, comprising: a body portion, having a light transmitting surface, a first reflective surface and a second reflective surface; wherein,
the light transmitting surface has a light inlet region and a light outlet region; the first reflective surface is inclined with respect to the light transmitting surface and is disposed in correspondence with the light inlet region; the second reflective surface is inclined with respect to the light transmitting surface and is disposed in correspondence with the light outlet region;
the body portion further has a bottom surface; the bottom surface is connected to the first reflective surface and the second reflective surface and is disposed opposite to the light transmitting surface;
the optical conduction element is configured to take the first reflective surface to reflect at least a portion of light, which is emitted from the light inlet region to reach the first reflective surface, to propagate to reach the light transmitting surface; the light transmitting surface is configured to allow the at least the portion of light to pass through to propagate to reach the second reflective surface; and the second reflective surface is configured to reflect the at least the portion of light to propagate out of the light outlet region.

2. The optical conduction element according to claim 1, further comprising: a first light absorbing film, wherein the first light absorbing film is disposed on the bottom surface.

3. The optical conduction element according to claim 1, wherein the bottom surface is a diffuse reflective surface.

4. The optical conduction element according to claim 1, wherein the body portion comprises a first sub-prism and a second sub-prism; the first reflective surface is disposed on the first sub-prism; the second reflective surface is disposed on the second sub-prism; the optical conduction element further comprises a second light absorbing film disposed at intersection between the first sub-prism and the second sub-prism; the second light absorbing film defines a light through aperture between the first sub-prism and the second sub-prism.

5. The optical conduction element according to claim 4, wherein a projection of the second light absorbing film on the first sub-prism has an opening facing towards the light transmitting surface.

6. The optical conduction element according to claim 5, wherein the second light absorbing film has a curved edge corresponding to at least a portion of an edge of the opening.

7. The optical conduction element according to claim 6, wherein the second light absorbing film has a plurality of curved edges that are periodically distributed and corresponding to the edge of the opening, and a radius of each of the plurality of curved edges is 0.1 mm-0.3 mm.

8. The optical conduction element according to claim 4, wherein the second light absorbing film comprises a first titanium film layer and two reflection-reducing film layers; the two reflection-reducing film layers are respectively disposed on two sides of the first titanium film layer; each of the two reflection-reducing film layers comprises a titanium dioxide layer and a silicon dioxide layer; the silicon dioxide layer is disposed on a side of the titanium dioxide layer away from the first titanium film layer; the titanium dioxide layer and the silicon dioxide layer in the reflection-reducing film layer are attached to each other.

9. The optical conduction element according to claim 8, wherein the second light absorbing film further comprises two first protective film layers; the two first protective film layers are respectively disposed on two sides of the first titanium film layer and between the first titanium film layer and the reflection-reducing film layer.

10. The optical conduction element according to claim 9, wherein a material of each of the two first protective film layers comprises silicon dioxide.

11. The optical conduction element according to claim 9, wherein the second light absorbing film further comprises two second titanium film layers; the two second titanium film layers are disposed between the two first protective film layers and the two reflection-reducing film layers.

12. The optical conduction element according to claim 11, wherein a thickness of each of the two second titanium film layers is less than a thickness of the first titanium film layer.

13. The optical conduction element according to claim 12, wherein the second light absorbing film further comprises two second protective film layers; one of the two second protective film layers is disposed between one of the two reflection-reducing film layers and a respective one of the two second titanium film layers; the other one of the two second protective film layers is disposed between the other one of the two reflection-reducing film layers and the other respective one of the two second titanium film layers; a material of each of the two second protective film layers comprises silicon dioxide, each of the two second protective film layers are attached to the titanium dioxide layer and each respective one of the two second titanium film layers.

14. The optical conduction element according to claim 8, wherein the second light absorbing film further comprises two first protective film layers, two second titanium film layers, and two second protective film layers;
one of the two reflection-reducing film layers, one of the two second protective film layers, one of the two second titanium film layers, one of the two first protective film layers, the first titanium film layer, the other one of the two first protective film layers, the other one of the two second titanium film layers, the other one of the two second protective film layers, and the other one of the two antireflective film layers are sequentially laminated;
a material of each of the two first protective film layers comprises silicon dioxide, and a material of each of the two second protective film layers comprises silicon dioxide.

15. The optical conduction element according to claim 14, wherein a thickness of the silicon dioxide layer is greater than a thickness of each of the two first protective film layers, and the thickness of each of the two first protective film layers is greater than a thickness of each of the two second protective film layers.

16. The optical conduction element according to claim 1, wherein the first reflective surface has a first reflective region, and the second reflective surface has a second reflective region; the optical conduction element further comprises a reflective film disposed on each of the first reflective region and the second reflective region.

17. The optical conduction element according to claim 16, wherein the reflective film comprises a first reflective enhancement film, a first protective film, an aluminum film, and a second protective film that are sequentially laminated; the first reflective enhancement film comprises a silicon dioxide layer and a titanium dioxide layer disposed on a side of the silicon dioxide layer facing the first protective film; each of the first protective film and the second protective film comprises an aluminum oxide layer attached to the aluminum film.

18. The optical conduction element according to claim 16, wherein the reflective film comprises a first reflective film, a silver film, and an aluminum film that are disposed in sequence;
the first reflective film comprises a silicon dioxide layer and a titanium dioxide layer disposed on a side of the silicon dioxide layer facing the silver film.

19. An image capturing module, comprising a lens, an image sensor, and an optical conduction element;
wherein the optical conduction element comprises: a body portion, having a light transmitting surface, a first reflective surface and a second reflective surface;
the light transmitting surface has a light inlet region and a light outlet region; the first reflective surface is inclined with respect to the light transmitting surface and is disposed in correspondence with the light inlet region; the second reflective surface is inclined with respect to the light transmitting surface and is disposed in correspondence with the light outlet region;
the body portion further has a bottom surface; the bottom surface is connected to the first reflective surface and the second reflective surface and is disposed opposite to the light transmitting surface;
the optical conduction element is configured to take the first reflective surface to reflect at least a portion of light, which is emitted from the light inlet region to reach the first reflective surface, to propagate to reach the light transmitting surface; the light transmitting surface is configured to allow the at least the portion of light to pass through to propagate to reach the second reflective surface; and the second reflective surface is configured to reflect the at least the portion of light to propagate out of the light outlet region; and
wherein the light inlet region is located corresponding to a light outlet side of the lens; the light outlet region is located corresponding to a light sensing surface of the image sensor.

20. An electronic device, comprising a housing and an image capturing module,
wherein the image capturing module comprises a lens, an image sensor, and an optical conduction element; the optical conduction element comprises: a body portion, having a light transmitting surface, a first reflective surface and a second reflective surface;
the light transmitting surface has a light inlet region and a light outlet region; the first reflective surface is inclined with respect to the light transmitting surface and is disposed in correspondence with the light inlet region; the second reflective surface is inclined with respect to the light transmitting surface and is disposed in correspondence with the light outlet region;
the body portion further has a bottom surface; the bottom surface is connected to the first reflective surface and the second reflective surface and is disposed opposite to the light transmitting surface;
the optical conduction element is configured to take the first reflective surface to reflect at least a portion of light, which is emitted from the light inlet region to reach the first reflective surface, to propagate to reach the light transmitting surface; the light transmitting surface is configured to allow the at least the portion of light to pass through to propagate to reach the second reflective surface; and the second reflective surface is configured to reflect the at least the portion of light to propagate out of the light outlet region;
wherein the light inlet region is located corresponding to a light outlet side of the lens; the light outlet region is located corresponding to a light sensing surface of the image sensor; and
wherein the housing defines a light inlet hole, the light inlet side of the lens is disposed corresponding to the light inlet hole.
